(19) United States
(12) Patent Application Publication
(10) Pub. No.: US 2016/0232565 A1
(43) Pub. Date: Aug. 11, 2016

(54) SYSTEMS AND METHODS FOR TARGETED ADVERTISING AND VEHICLE IDENTIFICATION VIA TIRE PRESSURE MONITORING SYSTEM (TPMS) SIGNALS

(71) Applicant: Nate Goergen, Papillion, NE (US)

(72) Inventor: Nate Goergen, Papillion, NE (US)

(21) Appl. No.: 14/714,446

(22) Filed: May 18, 2015

Related U.S. Application Data
(60) Provisional application No. 62/114,441, filed on Feb. 10, 2015.

(51) Int. Cl. G06Q 30/02; B60C 23/04; G06Q 10/00

(52) U.S. Cl. CPC G06Q 30/0255; G06Q 10/20; B60C 23/0479

(57) ABSTRACT

A system and method for identifying a vehicle via wireless signals emitted by Tire Pressure Monitoring System (TPMS) sensors, and using the identification to deliver behavioral targeted advertising or to track movement. This includes receiving, demodulating, and decoding wireless signals emitted by the TPMS sensors. Information contained in a TPMS transmission event may be used to correlate one or more TPMS sensors to a particular vehicle on which the TPMS sensors are installed, thereby providing a unique identification of the vehicle. Data extracted or derived from one or more TPMS transmission events may include the vehicle's inclusion or exclusion from one or more lists, historical traffic patterns or geographic movements of the vehicle, historical purchasing history or purchasing habits associated with the occupants of the vehicle, the previous service history of the vehicle, or the presence or absence of the vehicle at one or more geographic locations at recorded times.

### CROSS REFERENCE TO RELATED APPLICATIONS

This application claims the benefit of priority to U.S. 5 Provisional Application Ser. No. 61/144,441, filed Feb. 10, 2015, the content of which is hereby incorporated by reference in its entirety.

### BACKGROUND

Existing tire pressure monitoring systems (TPMS) are used to monitor and electronically communicate tire sensor information. As of Sep. 1, 2008, every vehicle in the U.S. weighing 10,000 pounds or less is required by law to include TPMS. TPMS sensor information may include tire pressure, tire temperature, or other sensor information. A TPMS module on each wheel may uniquely identify each tire. By providing tire pressure information, existing TPMS are used to help vehicle operators to ensure correct tire inflation. Correct tire inflation may increase fuel efficiency and reduce vehicle accidents due to under-inflated tires.

### BRIEF DESCRIPTION OF THE DRAWINGS

FIG. 1 illustrates a TPMS based behavioral targeted advertising system, in accordance with some embodiments.

FIG. 2 illustrates a TPMS based targeted customer system, in accordance with some embodiments.

FIG. 3 illustrates a TPMS based vehicle identification system, in accordance with some embodiments.

FIG. 4 illustrates a method for vehicle identification and tracking via TPMS signals, in accordance with some embodiments.

FIG. 5 is a block diagram illustrating an example of a machine, upon which one or more embodiments may be implemented.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

The present subject matter is directed to systems and methods for identifying a vehicle via wireless signals emitted by Tire Pressure Monitoring System (TPMS) sensors, and using the identification to deliver behavioral targeted advertising or track movement. This includes receiving, demodulating, and decoding wireless signals emitted by the TPMS sensors. The wireless communication of various TPMS sensors may include multiple protocols and multiple frequencies. Decoding the TPMS sensors includes extracting information contained in TPMS sensor transmissions, which may include TPMS sensor serial numbers, identification numbers, accelerometer data, tire temperature or inflation pressure data, data indicating whether the sensor is stationary or in motion, or other data transmitted by the TPMS sensor. Transmission of TPMS sensor data may be referred to as a “TPMS transmission event.”

Uniquely identifying TPMS information contained in a TPMS transmission event may be used to correlate one or more TPMS sensors to a particular vehicle on which the TPMS sensors are installed, thereby providing a unique identification of the vehicle. In an example, the TPMS identification may be associated with information previously recorded about the vehicle owner or driver. For example, a vehicle dealership may have a record associating a set of TPMS sensor identification numbers with the purchaser of that vehicle, or an automobile service shop may associate the vehicle TPMS identification with the person paying for the service. Additional information may be used to correlate an individual with the TPMS sensors. For example, a law enforcement officer may record the license plate or vehicle identification number (VIN), searching for an owner using the license plate or VIN, and retroactively associate the TPMS identification with an individual identified using the license plate or VIN. In this way, TPMS identification may be correlated with previous data to identify an owner whenever the TPMS identification is detected. In another example, the TPMS identification may be associated with the vehicle itself For example, a drive-through restaurant may associate a vehicle with the vehicle occupant's ordering history without needing to request or determine the identity of the driver or owner. The TPMS identification may be used to correlate the vehicle with previously recorded vehicle data, or may be used to generate a new record associating a current transaction with the TPMS identification. In this example, the TPMS identification anonymously identifies and records the previous ordering history of the vehicle's occupants in a manner similar to a supermarket customer loyalty card program. Because TPMS sensors are mandated by law, associating TPMS identification with a vehicle may alleviate some privacy concerns while retaining the features described herein. Data extracted or derived from one or more TPMS transmission events may be analyzed, derived, filtered, or interpreted before it may be used for automated analysis or presented to a user. Extracted or derived TPMS data may include the vehicle's inclusion or exclusion from one or more lists, historical traffic patterns or geographic movements of the vehicle, historical purchasing history or purchasing habits associated with the occupants of the vehicle, the previous service history of the vehicle, or the presence or absence of the vehicle at one or more geographic locations at recorded times. Implementation of the systems and methods described above may include various hardware components. One such system may include one or more antennas, amplifiers, demodulating circuits, demodulating software, processors, and wireless receiving devices designed to receive TPMS transmission event transmissions from one or more types of TPMS sensors.

The uniquely identifiable information derived from one or more TPMS transmission events may be correlated with the geographic location of the vehicle or the vehicle's individual TPMS sensors. Similarly, the uniquely identifiable information derived from one or more TPMS transmission events may be correlated with proximity data relating to the location of the TPMS sensors relative to one or more TPMS transmission event receiving apparatuses. This may be used to generate location data, such as a vector representing the location of the vehicle itself or the location of the vehicle's individual TPMS sensors with respect to the receiving apparatus. Similarly, the reception of TPMS transmission events from two or more receiving apparatuses may be correlated to produce a vector describing the movement, speed, or bearing of the vehicle at the time the TPMS transmission events were received.

Metadata associated with the TPMS transmission event and the environment surrounding the vehicle at the time the TPMS transmission event was received may be correlated with the TPMS transmission event. This may include the date and time that the TPMS transmission event occurred or photographic recordings of the vehicle associated with the TPMS transmission event at the time the TPMS transmission event occurred.

One or more unique identifiers contained in the TPMS transmission event may be used to correlate one or more TPMS sensors to information about the vehicle that produced the TPMS transmission event. This vehicle information may include the year, make, or model of the vehicle, the vehicle Identification Number (VIN), or the primary registered owner of the vehicle.

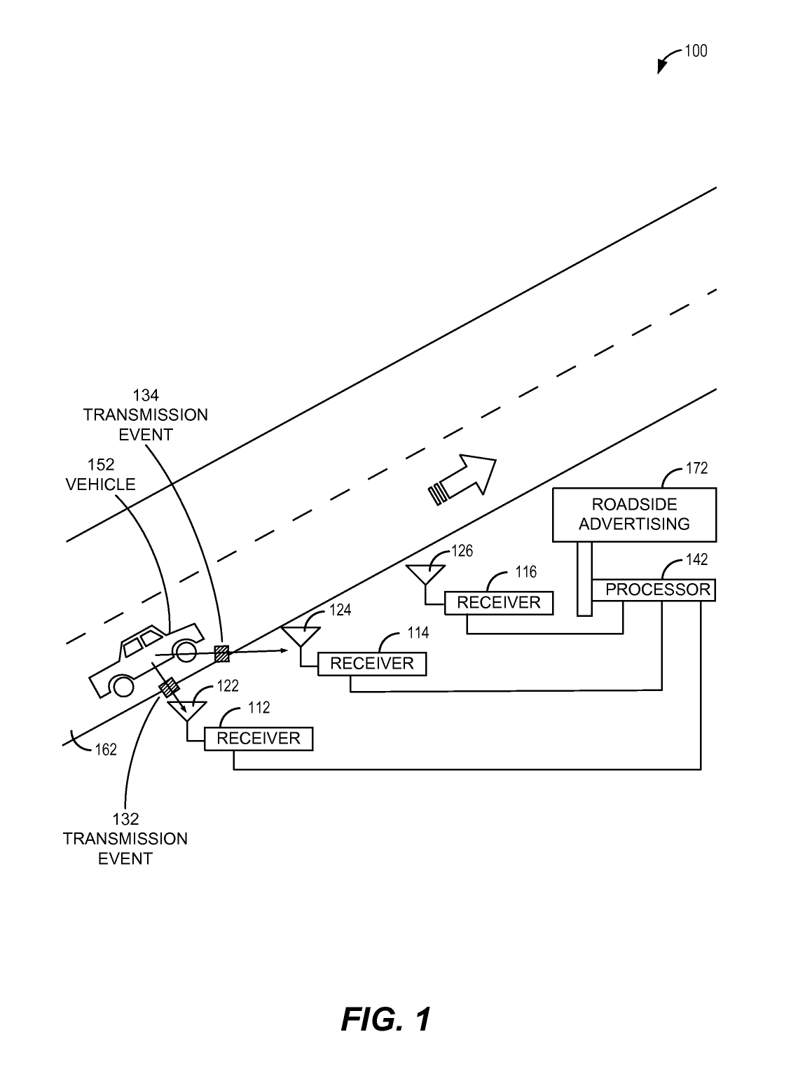

FIG. 1 illustrates a TPMS based behavioral targeted advertising system 100, in accordance with some embodiments. As shown in FIG. 1, one or more receivers 112, 114, 116 and one or more antennas 122, 124, 126 may be used to communicate one or more TPMS transmission events 132, 134. The TPMS transmission events 132, 134 may be routed to a processor 142 (e.g., advertising module), where the processor 142 may analyze the TPMS transmission events 132, 134 alone or in combination with additional data. Uniquely identifiable information derived from TPMS transmission events 132, 134 may be correlated with a vehicle 152 on a road 162, which may be used to deliver advertising targeted to the vehicle's occupants or the registered vehicle owner. Advertising content may be selected based on a single TPMS transmission event or it may be based on multiple TPMS transmission events, where multiple TPMS transmission events may be used to identify vehicle location, direction, speed, or other information. A vendor may use the uniquely identifiable information to identify the owner anonymously, the vendor may access previous purchases by the owner, and the vendor may use that purchasing history to select and deliver behavioral targeted advertising to vehicle occupants. In an example, a vehicle may be identified to be a Lexus brand car, and roadside advertising 172 (e.g., an electronic billboard) may be updated to advertise a nearby Lexus dealership. Targeted advertising applications may be triggered in response to historical purchasing habits, purchasing preferences, or purchasing history of the occupants of a particular vehicle or the vehicle's registered owner. Targeted advertising applications may be triggered in response to information regarding the year, make, model, service history of the vehicle, or other information. In another example, TPMS identification may be used to deliver targeted advertisements directly to the owner or occupants of the vehicle, such as through a vehicle radio, through in-vehicle communication systems, through personal cellular phones, or through other advertisement communication systems.

Data associated with the TPMS transmission event may be recorded, cataloged, or otherwise logged. This may include the association of a particular vehicle with one or more vehicle-based TPMS sensors, information about the vehicle derived from unique identifiers associated with the TPMS transmission event, the geographic location where the TPMS transmission event occurred, metadata associated with the TPMS transmission event, or other information. Metadata may include the geographic location where the TPMS transmission event was received, the date and time of the TPMS transmission event, photographic recordings of the vehicle or the environment around the vehicle at the time of the TPMS transmission event, data related to the proximity of the TPMS sensor to one or more receiving apparatuses, or other information. Metadata may also include derived vehicle motion vectors associated with the vehicle producing the TPMS transmission event, such as the bearing or speed of the vehicle's movements.

As shown in FIG. 1, multiple receivers 110, 120, 130 and antennas 115, 125, 135 may be used to track the progress of a vehicle 140 on a road 150. Though FIG. 1 shows one antenna 115, 125, 135 connected to each receiver 110, 120, 130, multiple antennas may be connected to each receiver 110, 120, 130, and each receiver may use a known location of multiple antennas to track the progress of a vehicle 140. Vehicle tracking may be used for applications involving traffic flow analysis, such as the gathering of anonymous traffic statistics related to toll road projects, public works planning and development, municipal transportation projects, road infrastructure planning and maintenance, or traffic congestion analysis. TPMS identification may enable traffic flow analysis for the purpose of environmental studies or “green city” activities, such as monitoring and analyzing vehicle type, vehicle weight, vehicle fuel consumption, vehicle fuel type, or tire inflation levels. Vehicle tracking may be used for non-anonymous traffic-related vehicle identification. For example, a TPMS-based toll road system may identify a vehicle via TPMS, retrieve a toll payment account associated with the vehicle, and debit the toll payment account. TPMS identification may also be used for computer-assisted vehicle navigation, autonomous vehicles, autonomous vehicle systems, or vehicle-to-vehicle communication networks.

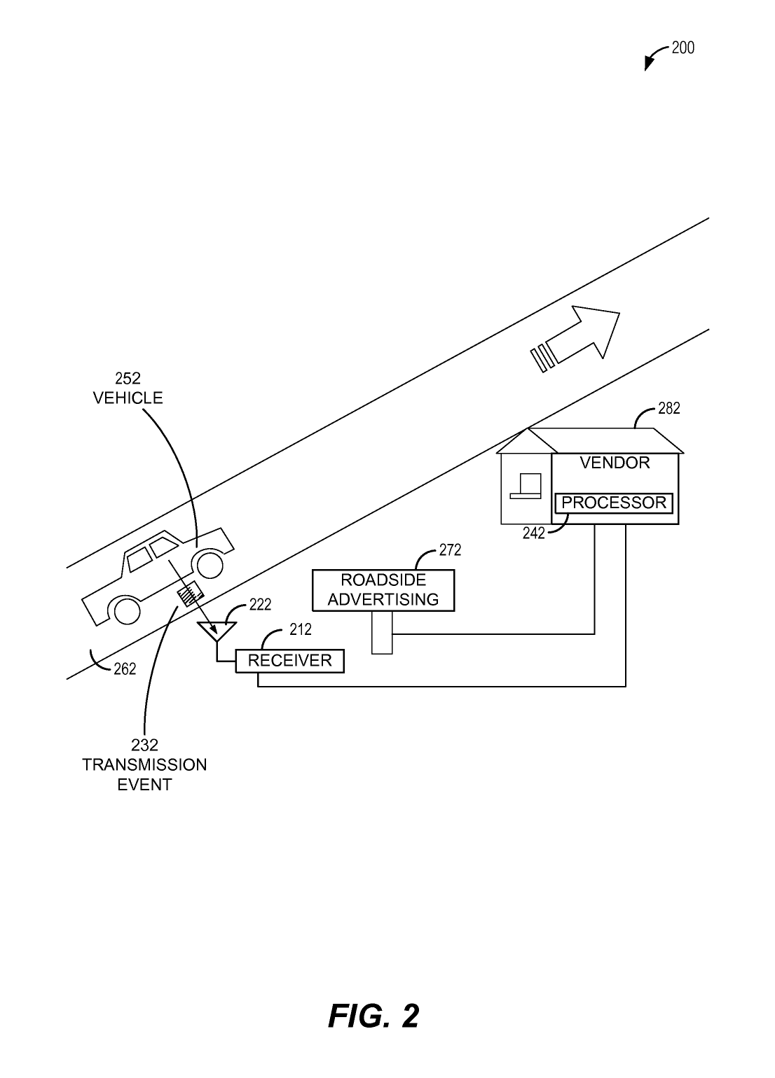

FIG. 2 illustrates a TPMS based targeted customer system 200, in accordance with some embodiments. The uniquely identifiable information derived from one or more TPMS transmission events 232 may be used by a vendor 282 (e.g., store) to identify the owner of the vehicle 252 anonymously, the vendor 282 may access previous purchases by the owner, and the vendor 282 may use that purchasing history to select and deliver behavioral targeted advertising to the vehicle's occupants. In an example, an automobile repair shop may access the historical service record of the vehicle, which may be used to suggest scheduled maintenance or recommend reexamination of a previous safety-critical repair. In another example, a drive-through vendor (e.g., restaurant, coffee shop, bank) may access the historical purchasing record of the vehicle, and may present a visual or audible advertisement at a menu board or at an order confirmation display board. TPMS identification may be used for automated retrieval, or automated data entry, of information related to the vehicle's owner or the vehicle itself, such as the service history of the vehicle or information about the vehicle or the vehicle's owner. Car manufacturers or service centers may use TPMS identification for issuance and enforcement of vehicle recall notifications, recommended or required vehicle maintenance, and tire inflation levels. Car insurance companies may use TPMS identification to track vehicle maintenance records, accelerometer readings from vehicles during movement, and tire inflation levels.

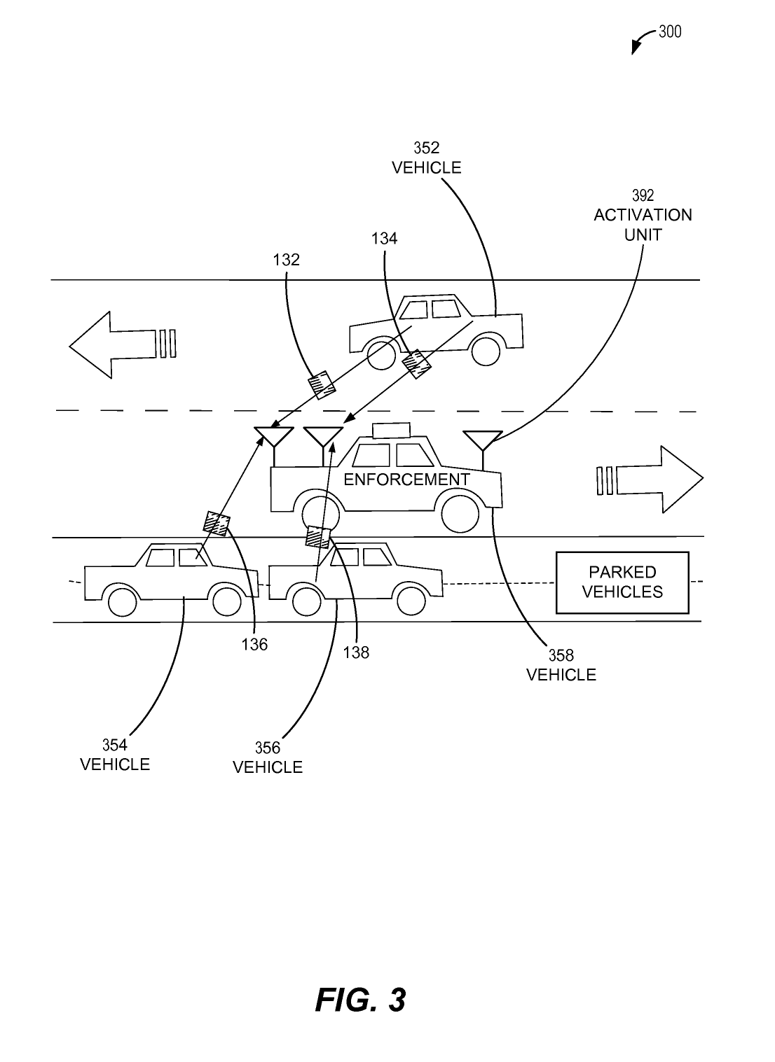

FIG. 3 illustrates a TPMS based vehicle identification system 300, in accordance with some embodiments. As shown in FIG. 3, a system may include an activation unit 392 to activate one or more TPMS sensors on a moving vehicle 352, or to activate one or more TPMS sensors on stationary vehicles 354 and 356. The activation unit 392 may be external to vehicles 352, 354, 356 on which the TPMS sensors are installed, such as an activation unit 392 installed on an enforcement vehicle 358. The activation unit 392 or other components of the system 300 may be specifically designed to activate TPMS sensors that are inactive (i.e. not currently transmitting). Activation of inactive TPMS sensors may be used to generate TPMS transmission events 132, 134, 136, 138 to support the method described herein, thus causing the TPMS sensors to generate TPMS transmission events upon request when queried. For example, one or more transmitting devices, antennas, modulators, and amplifier systems in the activation unit 392 may be designed to transmit TPMS sensor activation signals (e.g., “wake up” signals) for inducing TPMS sensor TPMS transmission events on command. These activation devices may be designed to elicit TPMS transmission events with a frequency or from a distance greater than would otherwise be used by TPMS transmission events that were configured using the vehicle's original TPMS design specifications.

As shown in FIG. 3, TPMS identification may be used for law enforcement activities related to lost or stolen vehicles. TPMS identification may use various TPMS information, including acceleration, activity state, or other information. For example, the TPMS information may include a Boolean flag to indicate whether the sensor is asleep (e.g., “parked” mode) or active (e.g., “moving”). Similar applications include towing and impound vehicles (i.e., tow trucks), vehicle repossession activities, and vehicle parking enforcement. Law enforcement entities may also use TPMS identification in locating lost or stolen vehicles, the identification of vehicles of interest related to specific ‘alerts’ (i.e. Silver Alerts/Amber Alerts), moving vehicle violations (i.e. speed and red-light cameras), and parking enforcement. Parking enforcement applications may include activities related to the enforcement of parking laws/regulations and the issuance or enforcement of parking violations and citations. For example, a TPMS-based parking enforcement system may record the presence of a vehicle, and TPMS information sent from the vehicle may indicate that the vehicle is in a parked state. Vehicle access applications may include enforcing the vehicle's physical access, admittance, or presence in an area, such as within restricted areas, campuses, gated areas, or parking lots. TPMS identification may be used for the lawful tracking or logging of vehicle location and moment by law enforcement agencies or other entities. For example, a TPMS-based vehicle location system may record the presence of a vehicle at a location for a specific duration, and TPMS information sent from the vehicle may indicate that the vehicle was in a parked state throughout the duration. Law enforcement and other agencies may use TPMS identification for counter-terrorism activities, such as identification and tracking of vehicles of interest.

TPMS tracking may be used by the vehicle owner or insurer. For example, instead of depending on a GPS location or a data connection to report the GPS location, TPMS could be used by a parent to track a child's location or speed at specific locations. Similarly, the person or company paying to insure the vehicle (or the insurance company itself) may use TPMS location or speed tracking at specific locations for insurance risk assessment purposes. Fixed external receivers or vehicle-internal receivers may be used. For example, a fixed receiver may be mounted at an accident-prone intersection, and vehicle speed or accelerometer data may be collected on a vehicle involved in an accident at that intersection. Data may be collected for statistical analysis, for fault assessment purposes, or for other purposes. Similarly, a receiver may be on-board the car itself, such as a wireless dongle that collects data, where the vehicle owner may upload the data from the dongle to participate in programs that reward safe driving behavior through decreased insurance premiums.

Implementation of the various TPMS transmission event receiving apparatuses and methods described above may include various hardware components. These hardware components may include specifically designed components, such as specifically designed antennas, amplifiers, demodulating circuits and software, or other components. The components may be specifically designed to receive TPMS transmission event transmissions from multiple protocols, over multiple frequencies, or from distances greater than the original design specification of the vehicle's TPMS. The components may be specifically designed to determine precisely the geographic location or proximity of TPMS sensors relative to the receiving apparatus. The components may be specifically designed for reception, demodulation, decoding, or recording of wireless signals emitted by multiple

TPMS sensor models made by multiple manufacturers spanning multiple protocols. The components may be specifically designed for extraction of information contained in TPMS sensor TPMS transmission events, such as TPMS sensor serial numbers, identification numbers unique or otherwise, accelerometer data, tire temperature/inflation level data, or other data that may uniquely identify a particular TPMS sensor or TPMS sensor model or manufacture.

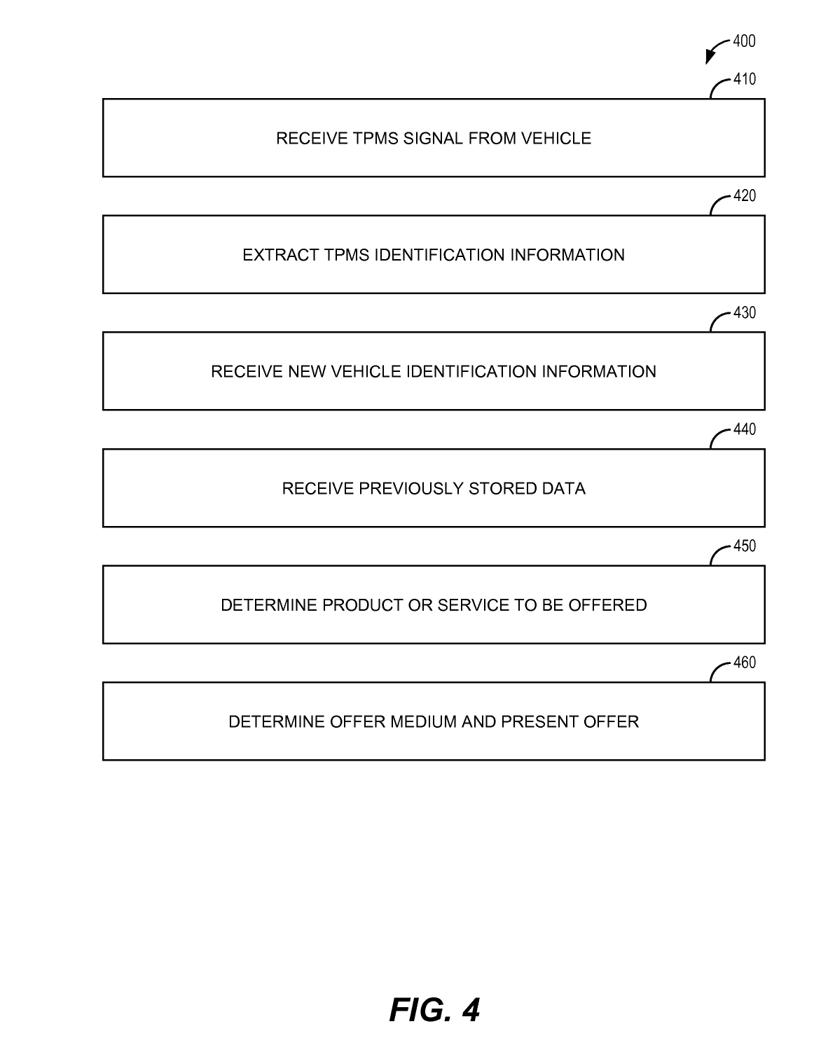

FIG. 4 illustrates a method for vehicle identification and tracking via TPMS signals 400, in accordance with some embodiments. Though various method steps are described with respect to method 400, various steps may be optional or added, as described below. Method 400 may include receiving 410 a TPMS signal from vehicle. TPMS identification information may be extracted 420 from the TPMS signal. Additional information may be extracted from the TPMS signal, such as tire pressure, tire temperature, accelerometer data, or other information. Vehicle identification information may be received 430. The new vehicle identification information may include a license plate, a vehicle identification number (VIN), a vehicle make, a vehicle model, a vehicle year, a vehicle owner name, or a vehicle occupant name. For example, an automobile service shop may enter a license plate, and license plate information and a new transaction may be associated with the TPMS identification information.

Method 400 may include receiving 440 previously stored data. The previously stored data may include a vehicle location history, a vehicle service record, a vehicle occupant purchase history, a previous vehicle location, or a vehicle occupant advertising preference. The previously stored data may be used to determine 450 a product or service to be offered. A drive-through vendor may retrieve a previous order, and may suggest the same order to a vehicle occupant. For example, a drive-through vendor may display text stating “You have ordered (or are considering ordering) product X, and we think you might also like products Y and Z.”

Method 400 may determine a medium for offering the product or service and present the offer 460. The medium may be based on a vehicle occupant advertising preference, based on the vehicle motion, or based on other factors. For example, a suggested service may be presented visually or audibly to a driver on a drive-through menu. A product or service may be presented on a billboard, and the duration or location of the billboard display may be determined based on the current location, direction, or speed of the vehicle. The product or service suggestion or purchasing behavior that lead to the suggestion may be presented to a vendor sales representative, such as a drive-through teller or a customer service operator, and the representative may suggest or up-sell the customer with the product or service. For example, the purchasing behavior may include recorded statistical data, a point-of-sale (POS) terminal may display the recorded statistical data to a sales representative, and the sales representative may use the information to tailor a sales pitch. An advertisement for a product or service may be transmitted to an electronic device within the vehicle. The electronic device may be a mobile electronic device that a user usually carries on his or her person, such as a cellular phone, an internet-connected tablet, or another mobile electronic device. The electronic device may be installed in the vehicle, such as a car stereo, an internet-connected rear-view mirror, an in-dash navigation system, the vehicle computer itself, or another electronic device installed in the vehicle. The advertisement may include an audible or visual advertisement, which may be transmitted for presentation in the vehicle. The advertisement may be presented immediately upon advertisement reception, may be presented after a time delay, or may be presented upon user-initiation of the advertisement. For example, an advertisement may be sent to an in-dash navigation display, the user may be prompted for the advertisement, and the advertisement may be presented upon user agreeing to view or listen to the advertisement.

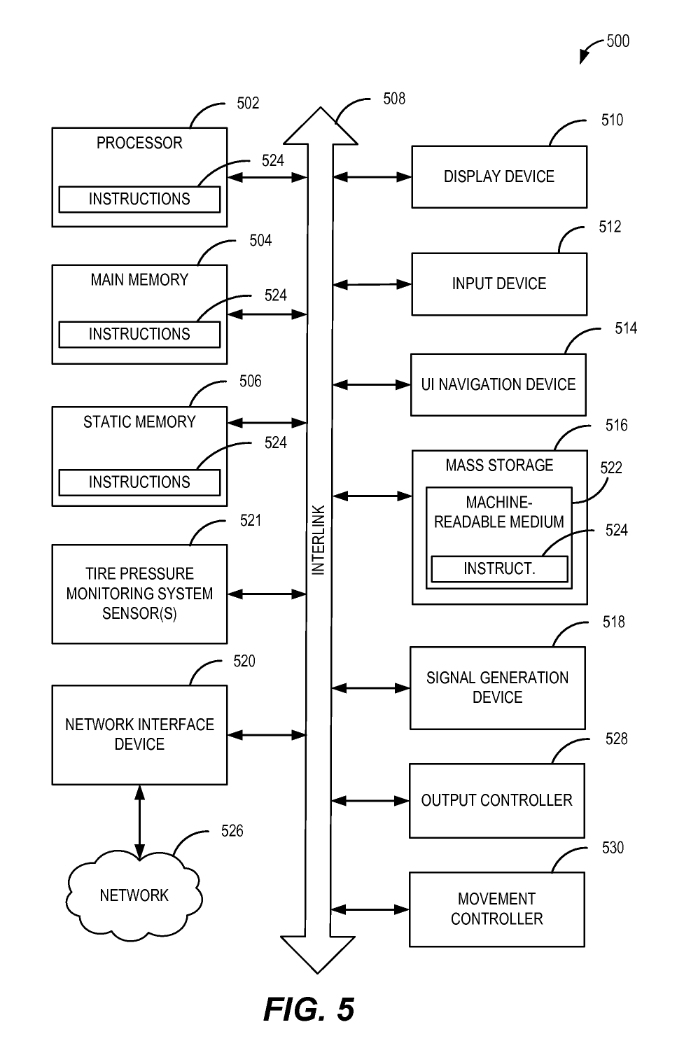

FIG. 5 is a block diagram 500 illustrating an example of a machine, upon which one or more embodiments may be implemented. Though a machine is described, the components within the block diagram 500 may be implemented on a chipset, such as on an integrated circuit (IC). Implementation of these components within a chipset may enable various improvements in efficiency. For example, various methods described herein may be implemented in firmware and executed in parallel on a dedicated chipset, such as the demodulation and decoding of multiple TPMS sensor protocols over multiple frequencies, which may provide improved efficiency over a purely software-based implementation. Conversely, the methods descried herein may be implemented as a pure software-based implementation, or any combination of software, firmware, and chipset, allowing for frequent software upgrades of fielded receivers as new TPMS sensors and protocol variations emerge.

In some embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 500 may include a hardware processor 502 (e.g., a central processing unit (CPU), a graphics processing unit (GPU), a hardware processor core, Field Programmable Gate Array (FPGA), or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more TPMS sensors 521. TPMS sensors may include a pressure sensor, a temperature sensor, an acceleration sensor, a gyroscope (e.g., rotation rate) sensor, or other sensors. The machine 500 may include an output controller 528, such as a serial (e.g., universal serial bus (USB), parallel, or other wired (e.g., Ethernet) or wireless (e.g., infrared (IR), Wireless LAN (WLAN), near field communication (NFC), etc.) connection to communicate or control one or more peripheral devices (e.g., a printer, card reader, etc.). The machine 500 may include a movement controller 530, where the movement controller may control a motor, mirrors, servos, or other movement to induce actual or apparent pixel motion.

The storage device 516 may include a machine-readable medium 522 on which is stored one or more sets of data structures or instructions 524 (e.g., software) embodying or used by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine-readable media.

Although the machine-readable medium 522 is illustrated as a single medium, the term “machine-readable medium” may include a single medium or multiple media (e.g., a centralized or distributed database, or associated caches and servers) configured to store the one or more instructions 524.

The term “machine-readable medium” may include any medium that is capable of storing, encoding, or carrying instructions for execution by the machine 500 and that cause the machine 500 to perform any one or more of the techniques of the present disclosure, or that is capable of storing, encoding, or carrying data structures used by or associated with such instructions. Non-limiting machine-readable medium examples may include solid-state memories, and optical and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to communicate wirelessly using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 500, and includes digital or analog communications signals or other intangible medium to facilitate communication of such software.

### Additional Notes & Example Embodiments

Example 1 includes a method for identifying, delivering behavioral targeted advertising to the owner or occupants of, or tracking the movement of, a vehicle via wireless signals emitted by Tire Pressure Monitoring System (TPMS) sensors, which will be referred to here as the “sensors,” the method including (a) receiving, demodulating, and decoding wireless signals emitted by the sensors; (b) extracting information contained in Sensor transmissions including but not limited to Sensor serial numbers, identification numbers, accelerometer data, tire temperature/inflation pressure data, and/or other data transmitted by the Sensor, which will be referred to as a TPMS Transmission “event”; and (c) the use of identifiers contained in one or more events to correlate one or more sensors to the particular vehicle on which the sensors are installed, referred to herein as the “vehicle.”

Example 2 includes the method of example 1, wherein uniquely identifiable information derived from one or more events is correlated with the registered owner of the vehicle, referred to herein as the “owner”, and this correlation is used to deliver advertising targeted to the vehicle's occupants or the registered owner of the vehicle, including information regarding the owner's previous purchasing history, the historical service record of the vehicle, and/or historical purchasing habits or preferences of the vehicle's occupants or owner.

Example 3 includes the method of example 1, wherein uniquely identifiable information derived from one or more events is correlated with the geographic location of the vehicle or the vehicle's individual sensors, and/or proximity data relating to the location of the sensors relative to one or more event receiving apparatuses, thus generating location data including but not limited to a vector representing the location of the vehicle itself or the location of the vehicle's individual sensors with respect to the receiving apparatus.

Example 4 includes the method of example 1, wherein the reception of events from two or more receiving apparatuses is correlated to produce a vector describing the movement, speed, and/or bearing of the vehicle at the time the events were received.

Example 5 includes the method of example 1, wherein metadata associated with the event and the environment surrounding the vehicle at the time the event was received is correlated with the event, including but not limited to the date and time that the event occurred and/or photographic recordings of the vehicle associated with the event at the time the event occurred.

Example 6 includes the method of example 1, wherein one or more unique identifiers contained in the event are used to correlate one or more sensors to information about the vehicle that produced the event, including but not limited to the year, make, and/or model of the vehicle, the vehicle Identification Number (VIN), and/or the primary registered owner of the vehicle.

Example 7 includes the methods of any of examples 2, 3, 4, 5, or 6, wherein data associated with the event is recorded, cataloged, or otherwise logged, including but not limited to the association of one or more sensors to a particular vehicle, information about the vehicle derived from unique identifiers associated with the event, the geographic location where the event occurred, metadata associated with the event including but not limited to the geographic location where the event was received, the date and time of the event and/or photographic recordings of the vehicle and/or the environment around the vehicle at the time of the event, data related to the proximity of the Sensor to one or more receiving apparatuses, and any derived vehicle motion vectors associated with the vehicle producing the event including but not limited to the bearing and/or speed of the vehicle's movements.

Example 8 includes the method of example 7, wherein data extracted from one or more events, or derived from information contained in one or more events, is analyzed, derived, or filtered before it is used for automated analysis or presented to a human for interpretation, including but not limited to the vehicle or vehicle owners' inclusion or exclusion from one or more lists, historical traffic patterns and/or geographic movements of the vehicle, historical purchasing history or purchasing habits associated with the occupants of the vehicle, the previous service history of the vehicle, and/or the presence or absence of the vehicle at one or more geographic locations at recorded times.

Example 9 includes a system for receiving TPMS transmission events from vehicles for the purposes of vehicle identification, delivering advertising targeted to a vehicle's current occupants or registered owner, and/or the tracking of a vehicle's movements, the system including (a) one or more antennas, amplifiers, demodulating circuits and/or software, and wireless receiving devices designed to receive TPMS event transmissions from one or more types of sensors, including but not limited to antennas, amplifiers, demodulating circuits and software, and devices designed to receive TPMS event transmissions using multiple protocols, over multiple frequencies, or from distances greater than the original design specification of the vehicle's TPMS; (b) one or more antennas, amplifiers, demodulating circuits and/or software, and receiving devices designed to precisely determine the geographic location and/or proximity of sensors relative to the receiving apparatus; (c) reception, demodulation, decoding, and/or recording of wireless signals emitted by sensors; (d) extraction of information contained in Sensor events, including but not limited to Sensor serial numbers, identification numbers unique or otherwise, accelerometer data, tire temperature/inflation level data, and/or other data that may uniquely identify a particular Sensor and/or Sensor model or manufacture; and (e) an apparatus to activate sensors that are inactive (i.e. not currently transmitting), for the purpose of generating events to support the method of examples 1, 2, 3, 4, 5, 6, 7, or 8, thus causing the sensors to generate events upon request when queried, including but not limited to one or more transmitting devices, antennas, modulators, and amplifier systems designed to transmit Sensor ‘wake up’ or activation signals for the purpose of inducing Sensor events on command and/or generating Sensor events with a frequency greater than, and/or from a distance greater than, that specified by the vehicle's original TPMS design specifications.

Each of these non-limiting examples can stand on its own, or can be combined in various permutations or combinations with one or more of the other examples.

Conventional terms in the fields of neural networks and aviation have been used herein. The terms are known in the art and are provided only as a non-limiting example for convenience purposes. Accordingly, the interpretation of the corresponding terms in the claims, unless stated otherwise, is not limited to any particular definition. Thus, the terms used in the claims should be given their broadest reasonable interpretation.

Although specific embodiments have been illustrated and described herein, it will be appreciated by those of ordinary skill in the art that any arrangement that is calculated to achieve the same purpose may be substituted for the specific embodiments shown. Many adaptations will be apparent to those of ordinary skill in the art. Accordingly, this application is intended to cover any adaptations or variations.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer-readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read-only memories (ROMs), and the like.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. §1.72(b), to allow the reader to quickly ascertain the nature of the technical disclosure and is submitted with the understanding that it will not be used to interpret or limit the scope or meaning of the claims. In addition, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the embodiments should be determined with reference to the appended claims, along with the full scope of equivalents to which such claims are entitled.

The following statements are potential claims that may be converted to claims in a future application. No modification of the following statements should be allowed to affect the interpretation of claims, which may be drafted when this provisional application is converted into a regular utility application.

What is claimed is:

1. A method for targeted advertising via tire pressure monitoring system (TPMS) signals, the method including:
receiving a TPMS signal from a vehicle;
extracting TPMS identification information from the received TPMS signal;
receiving a previously stored data associated with the vehicle; and
determining a product or service to be offered based on the previously stored data.

2. The method of claim 1, wherein the previously stored data includes a vehicle location history, a vehicle service record, a vehicle occupant purchase history, a previous vehicle location, or a vehicle occupant advertising preference.

3. The method of claim 1, further including:
receiving a previous location; and
determining a vehicle motion attribute by comparing the previous location with a current location.

4. The method of claim 3, further including determining an advertising location based on the vehicle motion attribute.

5. The method of claim 1, wherein:
the previously stored data is associated with the TPMS identification information; and
receiving the previously stored data includes retrieving the previously stored data based on the TPMS identification information.

6. The method of claim 1, further including:
receiving a new vehicle identification information, wherein receiving the previously stored data includes retrieving the previously stored data based on the new vehicle identification information; and
associating the previously stored data with the TPMS identification information.

7. The method of claim 6, wherein the new vehicle identification information includes a license plate, a vehicle identification number (VIN), a vehicle make, a vehicle model, a vehicle year, a vehicle owner name, or a vehicle occupant name.

8. The method of claim 1, further including presenting an advertisement for the product or service to a vehicle occupant.

9. The method of claim 8, wherein the advertisement is presented on a billboard, on a drive-through menu board, or on an order confirmation display.

10. The method of claim 1, further including displaying statistical data describing the representation of the product or service to a sales representative.

11. The method of claim 1, further including displaying a purchasing behavior associated with the suggestion to the sales representative.

12. The method of claim 1, further including transmitting a digital advertisement for the product or service to an electronic device within the vehicle.

13. The method of claim 1, further including:
receiving a new transaction record; and
associating the new transaction record with the TPMS identification information.

14. A method for vehicle identification and tracking via tire pressure monitoring system (TPMS) signals, the method including:
receiving TPMS identification data, the TPMS identification data associated with a vehicle of interest;
receiving a TPMS signal;
extracting TPMS identification information from the received TPMS signal;
determining the TPMS identification information matches the TPMS identification data; and
identifying the vehicle as the vehicle of interest.

15. The method of claim 14, further including sending a TPMS interrogation signal to a TPMS system on a vehicle, wherein receiving the TPMS signal is in response to the TPMS interrogation signal.

16. The method of claim 14, further including receiving vehicle identification information, wherein receiving the TPMS identification data includes retrieving the TPMS identification data based on the vehicle identification information.

17. The method of claim 15, wherein the vehicle identification information includes a license plate, a vehicle identification number (VIN), a vehicle make, a vehicle model, a vehicle year, a vehicle owner name, or a vehicle occupant name.

18. A system for vehicle identification and tracking via tire pressure monitoring system (TPMS) signals, the system including:
a TPMS receiver configured to receive a TPMS signal from a vehicle; and
a processor configured to:
extract TPMS identification information from the received TPMS signal;
receive a previously stored data associated with the vehicle; and
determine a product or service to be offered based on the previously stored data.

19. The system of claim 18, further including an advertising presentation device configured to present a targeted advertisement of the product or service to a vehicle occupant.

20. The system of claim 18, further including a TPMS interrogation device configured to send a TPMS interrogation signal to a TPMS device on the vehicle, the TPMS interrogation signal causing the TPMS device to send the TPMS signal.
